(19) United States
(12) Patent Application Publication
(10) Pub. No.: US 2024/0370887 A1
(43) Pub. Date: Nov. 7, 2024

(54) PREDICTING PRICES OF NON-FUNGIBLE TOKENS

(71) Applicant: LUKKA, INC., Naples, FL (US)

(72) Inventor: Sailendra Prasanna Mishra, Sunnyvale, CA (US)

(21) Appl. No.: 18/143,850

(22) Filed: May 5, 2023

(51) Int. Cl. G06Q 30/0202

(52) U.S. Cl. CPC G06Q 30/0202

(57) ABSTRACT

An example method of predicting prices of non-fungible tokens (NFTs) includes the operations of: receiving an identifier of a target nun-fungible token (NFT); responsive to determining, based on first trading data associated with the target NFT, that the target NFT fails to satisfy an active trading frequency criterion, identifying a subset of similar NFTs including at least a predefined number of NFTs that satisfy a chosen similarity criterion based on their respective similarity scores with the target NFT, wherein the subset of similar NFTs is associated with at least a predefined number of reported trades within a predefined period; and predicting the price of the target NFT based on second trading data associated with the identified subset of similar NFTs.

### TECHNICAL FIELD

The present disclosure is generally related to computing systems, and more specifically relates to methods and systems for determining prices of non-fungible tokens.

### BACKGROUND

Non-Fungible Tokens (NFT) is a digital object (e.g., a media file, an image file, an executable file, etc.) the ownership of which is recorded and verified by a blockchain. The digital objects may include visual art objects, audio- and/or video-streams, computer games, web domains, etc. Powered by blockchain technology, the ownership of NFTs is easily verifiable, thus offering a powerful tool to own and trade digital objects. NFTs find their applications in various industries. NFTs may be traded in cryptocurrencies in various marketplaces.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example distributed computing system operating in accordance with aspects of the present disclosure;

FIG. 2 schematically illustrates an example data ingestion workflow implemented by a computing system operating in accordance with aspects of the present disclosure;

FIG. 3 schematically illustrates an example structure of a normalized transaction record;

FIG. 4 schematically illustrates an example structure of a neural network implementing an autoencoder in accordance with aspects of the present disclosure;

FIG. 5 is a flowchart of a method of predicting the price of a specified target NFT, implemented by a computing system operating in accordance with aspects of the present disclosure; and

FIG. 6 is a flowchart of a method of identifying a set of NFTs that are similar, in view of a chosen similarity score, to a specified target NFT, implemented by a computing system operating in accordance with aspects of the present disclosure;

FIG. 7 is a flowchart of a method of selecting a layer of the decoder stage of an autoencoder that is employed for extracting visual features from an NFT image by a computing system operating in accordance with aspects of the present disclosure.

FIG. 8 depicts a block diagram of an example computing system operating in accordance with the examples of the present disclosure.

### DETAILED DESCRIPTION

Described herein are systems and methods for predicting prices of non-fungible tokens (NFTs).

In the absence of a generally accepted valuation methodology, various NFT valuation efforts may apply a wide variety of valuation techniques thus failing to produce consistent or reproducible results. Furthermore, NFT market fragmentation leads to scarcely available and/or unreliable trading data. The above-noted deficiencies of methodology and trading data may be further exacerbated by the absence of reliable reference data to be utilized in computations. The noted lack of methodology and reliable data would unavoidably result in the absence of efficient computer-based implementations that would be capable of produce reliable NFT valuations.

Aspects of the present disclosure address the above-noted and other deficiencies by providing technology that implements a transparent, data-driven NFT valuation methodology. The systems and methods of the present disclosure predict NFT prices based on NFT attributes, consistent reference data, and the available historical and/or real-time trading data from multiple exchanges, thus ensuring consistent and accurate representations and calculations.

Accordingly, valuation of a target NFT may be performed by applying one or more valuation models, which may be chosen based on the lifecycle stage of the target NFT and/or availability of trading data that is pertinent to the target NFT.

In the beginning of its lifecycle (the post-mint stage), an NFT is likely to have little or no available pertinent trading data. Valuation of a post-mint NFT may be performed by a post-mint valuation model, which, in the absence of pertinent trading data may predict the NFT price based on the traits of the NFT.

An NFT collection is a set of NFTs that share one or more attributes (e.g., are created by the same artist, are issued by the same entity, are issued on the same date or within a defined period of time, conform to a single artistic style, etc.). NFT traits are specific visual attributes differentiating the ornamental design of the target NFT from other NFTs, such as background, foreground, color scheme, specific elements of profile pictures (PFPs), etc.

As an NFT progresses through its lifecycle, it may reach the thinly traded stage, which may be reached by attaining a certain number of reported trades associated with the target NFT and/or other NFTs in the same NFT collection. The generalized model predicts the price of the target NFT based on the available trading data (e.g., transaction data retrieved from one or more blockchains) associated with the target NFT and/or related or similar NFTs (e.g., other NFTs in the same NFT collection as the target NFT and/or NFTs outside of that collection but sharing certain attributes with the target NFT).

Finally, an NFT may reach an active trading stage (e.g., when the number of reported trades of the target NFT exceeds or is equal to the chosen active trading frequency threshold). Valuation of an actively traded NFT may be performed by a lagged model, which predicts the price of the target NFT based on a cryptoasset market movement indicator and the available trading data associated with the target NFT, as described in more detail herein below.

Thus, the systems and methods described herein improve the accuracy, reliability, and efficiency of NFT price computation. The systems and methods described herein may be implemented by hardware (e.g., general purpose and/or specialized processing devices, and/or other devices and associated circuitry), software (e.g., instructions executable by a processing device), or a combination thereof. In an illustrative example, a computing system implementing the systems and methods of the present disclosure may be provided by one or more virtual or physical execution environments (e.g., virtual or physical servers)

Various aspects of the above referenced methods and systems are described in details herein below by way of examples, rather than by way of limitation.

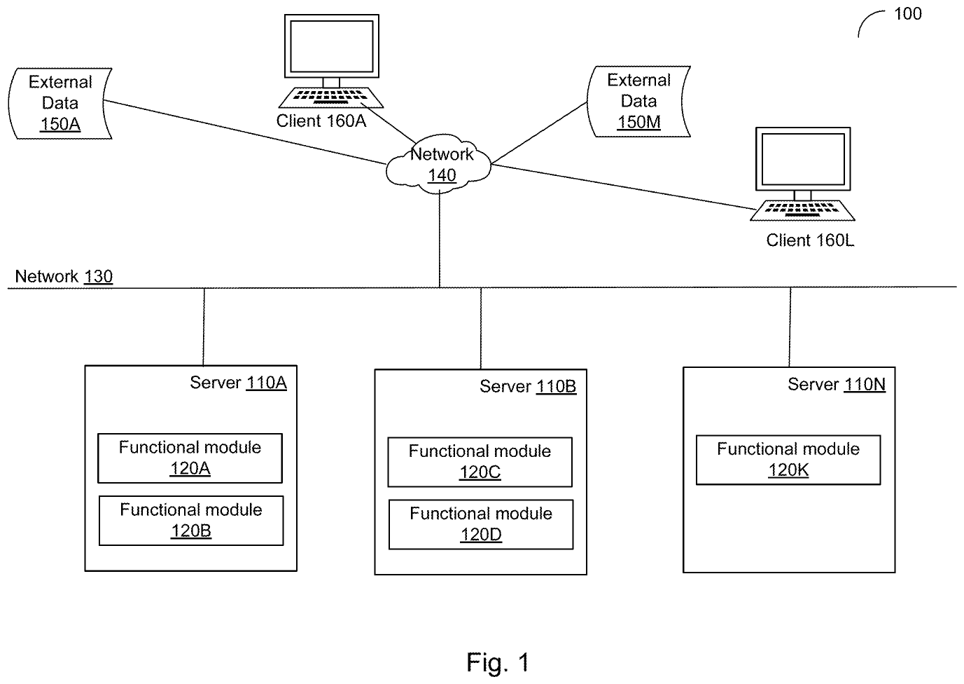

FIG. 1 schematically illustrates an example distributed computing system 100 operating in accordance with aspects of the present disclosure. The computing system 100 may include one or more servers 110A-110N which implement respective virtual or physical execution environments running one or more functional modules 120A-120K implementing the NFT valuation methods described herein. “Functional module” or “module” herein refers to an executable code and its dependencies that run in one or more physical (e.g., servers) or virtual execution environments (e.g., virtual machines) to collectively implement a set of interrelated data processing actions. The dependencies may include, e.g., system and application libraries, application programming interface (API) definitions, media files, graphical user interface (GUI) definition files, etc.

In some implementations, the servers 110A-110N may be interconnected by one or more networks 130, which may include public and/or private networks. In some implementations, the servers 110A-110N may reside within a public or a private cloud. In some implementations, the servers 110A-110N may include one or more clusters of compute nodes, one or more storage nodes, and/or one or more presentation nodes.

In some implementations, the servers 110A-110N may be interconnected, via one or more external networks 140, to one or more external data feeds 150A-150M. In an illustrative example, the external data feeds 150A-150M may provide, in real-time and/or in batch mode, trading data from multiple cryptoasset exchanges and/or reference data to be utilized in computing the NFT valuations, as described in more detail herein below.

The servers 110A-110N may be accessible, via one or more networks 130 and/or 140, by client devices 160-160L, which may be represented, e.g., by terminals, personal computers, mobile computing devices, etc. The client devices 160-160K may be equipped with respective graphical user interfaces (GUIs). The input data received through the GUI(s) may be utilized for building a query to be forwarded to one or more servers 110A-110N. The response data returned by a server 110 in response to the query may be visually rendered by the requesting client device 160 in the form of text, tables, graphs, diagrams, etc.

Various auxiliary components, such as firewalls, routers, switches, consoles, etc., are omitted from FIG. 1 for clarity and conciseness.

As noted herein above, the computing system 100 may receive the trading data from multiple cryptoasset exchanges and/or other external data sources. In some implementations, the trading data may be pre-processed by a data ingestion workflow before it is used by computing system 100 for NFT valuation and/or other data processing tasks.

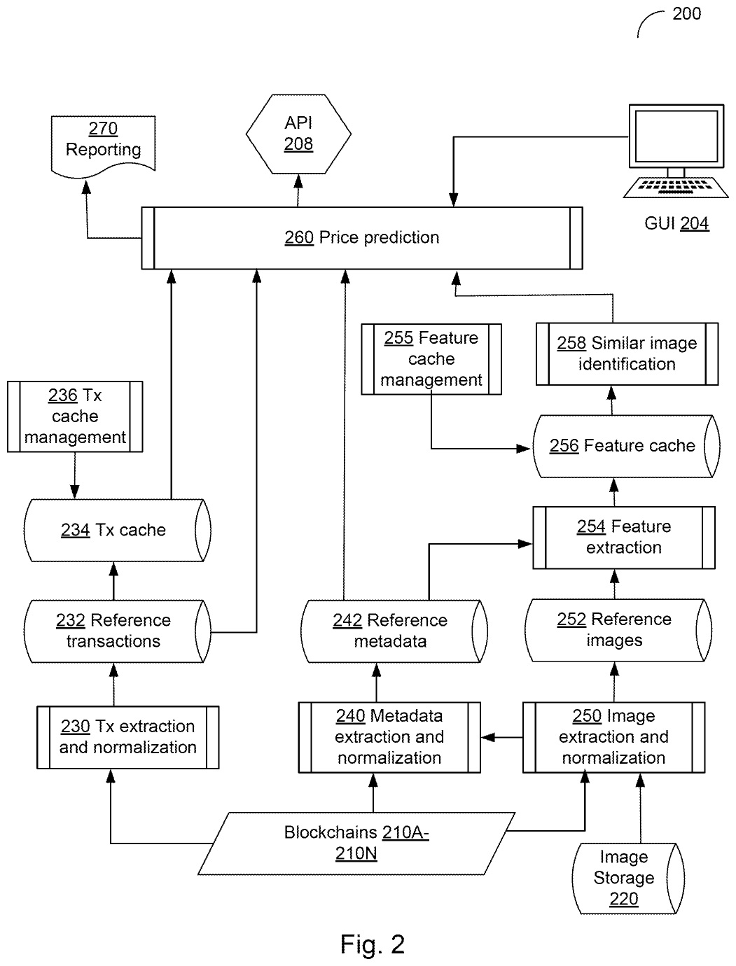

FIG. 2 schematically illustrates an example data ingestion workflow 200 implemented by a computing system operating in accordance with aspects of the present disclosure. Workflow 200 and/or each of its individual functions, routines, subroutines, or operations may be implemented by one or more software modules running in one or more virtual or physical execution environments (e.g., virtual or physical servers) or collocated with other servers or applications. In an illustrative example, workflow 200 may be implemented by the example distributed computing system 100 of FIG. 1. As noted herein above, valuation of a specified target NFT may be performed by applying, to the target NFT, one or more valuation models, which may be selected based on certain attributes of the target NFT and/or the available trading data that is pertinent to the target NFT.

As schematically illustrated by FIG. 2, the workflow 200 may be initiated and/or receive its input parameters via graphical user interface (GUI) 204 and/or application programming interface (API) 208. In some implementations, the input parameters may include, e.g., identifiers of one or more target NFTs for which the predicted price are requested.

In an illustrative example, an NFT may be identified by an identifier of the blockchain on which the NFT is recorded, an optional identifier of the NFT collection associated with the NFT, and an identifier of the token associated with the NFT. The token may be identified by an address on the blockchain. In some implementations, the NFT is also associated with a Universal Resource Identifier (URI) referencing, e.g., one or more images associated with the NFT.

The workflow 200 may continuously (in real-time) or periodically (in batches) receive, from one or more blockchains 210A-210N transaction information and associated metadata which can be fed to the transaction extraction and normalization module 230, metadata extraction and normalization module 240, and image extraction and normalization module 250.

In an illustrative example, each raw transaction record received from a blockchain 210A-210N may reflect an NFT trade and thus may include an identifier of the exchange, the transaction time, an identifier of the NFT being traded, and the traded price of the NFT. In some implementations, a raw transaction record may further fully identify the parties to the transaction, pseudonymize the parties, or anonymize the parties. In an illustrative example, the parties to a transaction may be identified by their respective account identifiers. In another illustrative example, the transaction record may reference the parties to a transaction by their pseudonyms; a pseudonym associated with a party may be generated from a party identifying information by an irreversible transformation, such that each party identifier is transformed into a corresponding pseudonym, thus exclusively associating the pseudonym with the party identifying information. In another illustrative example, the parties to a transaction may be anonymized, i.e., the raw transaction record may be pre-processed by the transaction extraction and normalization module 230 to exclude any party identifying information.

While identification of the parties to the transaction is not required for prediction of NFT prices by systems and methods operating in accordance with aspects of the present disclosure, the party identifying information or pseudonyms may in some implementations be utilized for identifying intra-group transactions performed between a group of related parties; such transactions may be excluded from consideration and/or given smaller weights as compared to arm-length transactions.

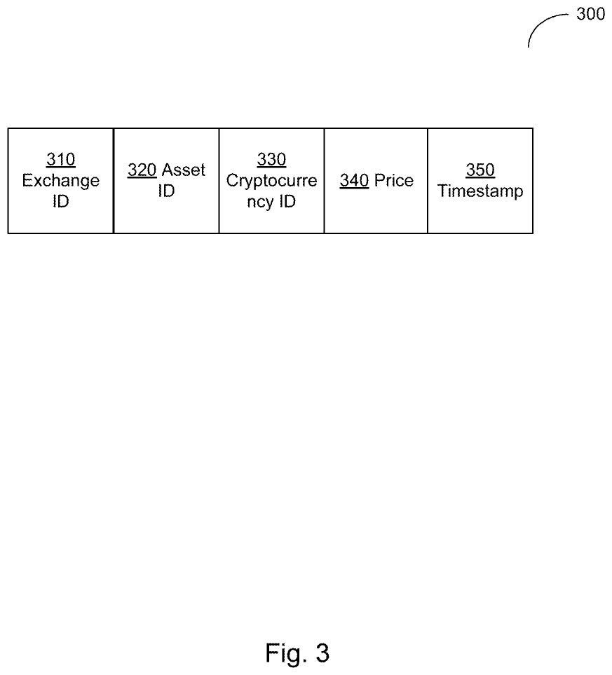

The transaction extraction and normalization module 230 may translate the raw transaction records into a set of normalized transaction records conforming to a chosen format. Each normalized transaction record may reflect a corresponding NFT trade. As schematically illustrated by FIG. 3, each normalized transaction record 300 may include an identifier 310 of the exchange that has executed the transaction, an identifier 320 of the asset (e.g., NFT identifier) being traded, the cryptocurrency 330 exchanged for the asset being traded, the traded price 340 of the asset, and the timestamp 350 of the transaction. In some implementations, the identifier 320 of the asset being traded may include an identifier of the blockchain on which the traded NFT is recorded, an optional identifier of the NFT collection associated with the NFT, and an identifier of the token associated with the NFT.

In some implementations, translating the raw transaction records into the normalized transaction records may further involve validating and normalizing asset identifiers (e.g., by comparing an asset identifier specified by a transaction record to a reference list of asset identifiers). In an illustrative example, translating the raw transaction records into the normalized transaction records may further involve validating and/or modifying various other transaction record fields. In another illustrative example, translating the raw transaction records into the normalized transaction records may further involve converting the transaction price into a corresponding price in a chosen cryptocurrency (e.g., ETH). In another illustrative example, translating the raw transaction records into the normalized transaction records may further involve appending, to the normalized transaction record, a weight coefficient charactering the exchange that has provided the original raw transaction record. In another illustrative example, translating the raw transaction records into the normalized transaction records may further involve discarding the raw transaction records that fail to satisfy one or more filtering conditions that are defined based on one or more transaction attributes.

The resulting normalized set(s) of transaction records may be stored in volatile and/or non-volatile memory, such as the reference transaction database 232. In some implementations, the normalized transaction records stored in the reference transaction database 232 may be indexed by one or more fields, such as NFT identifier, collection identifier, exchange identifier, etc.

In order to improve the efficiency of computations, at least a subset of the normalized transaction records satisfying a filtering condition specifying asset identifier (e.g., an NFT identifier and/or NFT collection identifier), transaction time, and/or other parameters may be cached in the transaction cache 234 residing in a volatile and/or non-volatile memory accessible by the price prediction module 260 (e.g., in a RAM memory buffer of a computer system running the price prediction module 260). In some implementations, the transaction records may be stored in the transaction cache 234 in a data structure that preserves a chronological order of their respective timestamps, such as a queue or a linked list.

The transaction cache management module 236 may implement a cache eviction policy to evict, from the transaction cache 234, certain transaction records, e.g., based on their timestamps and/or other attributes.

In some implementations, should the price prediction module 260 fail to locate, in the transaction cache 234, requisite transaction records for predicting the price of a certain NFT, the price prediction module 260 may search the reference transaction database 232 and retrieve any pertinent transaction records from the reference transaction database 232.

The metadata extraction and normalization module 240 may extract, from the raw transaction records and/or NFT images certain non-visual NFT attributes. In some implementations, the metadata extraction and normalization module 240 may identify and extract the keywords associated with the target NFT. The identified keywords and their synonyms may be stored in the reference metadata database 242, from which they may be retrieved by the feature extraction module 254 (e.g., for extracting non-visual features of the NFTs).

The image extraction and normalization module 250 may retrieve NFT images from locations on the external image storage 220 that are referenced by the raw transactions (e.g., NFT minting transactions) retrieved from the blockchains 210A-210N. Pre-processing of the raw images may involve resizing the images to a predefined size, formatting the images to a predefined standard, adjusting the resolution of the images to a predefined resolution, and/or adjusting the color scheme of the images to a predefined color scheme. The pre-processed images may be stored in the reference image database 252, from which they may be retrieved by the feature extraction module 254 for extracting visual features of the images.

In some implementations, the feature extraction module 254 may be implemented by the encoder stage of an autoencoder, which is a multi-layer neural network including an encoder stage the output of which is fed to a decoder stage. The autoencoder may be trained to produce the encoding of the input by the encoder stage and then reverse the encoding (i.e., restore the original input) by the decoder stage. Thus, the trained autoencoder effectively detects certain characteristic features of the input vector (e.g., of a digital representation of an NFT image), which are referred to as “visual features” herein.

The visual and non-visual NFT features extracted from NFT images and/or transaction records by the feature extraction module 254 may be stored in the feature cache 256 residing in a volatile and/or non-volatile memory accessible by the similar image identification module 258 (e.g., in a RAM memory buffer of a computer system running the similar image identification module 258). The feature cache management module 255 may implement a cache eviction policy to evict, from the feature cache 256, certain cached NFT features, e.g., based on their timestamps and/or other attributes.

In some implementations, an NFT feature vector may be evicted if the latest reported trade associated with the NFT satisfies a staleness condition that compares, to a predefined low sensitivity threshold, the time decay factor computed based on the most recent transaction date, as described in more detail herein below.

The similar image identification module 258 may utilize the extracted visual features for identifying visually similar images for a given NFT, which may be performed based on pairwise image similarity scores. In an illustrative example the similar image identification module 258 may compute the pairwise image similarity modules of a specified target NFT with each of a set of candidate NFTs. The set of candidate NFTs may include NFTs from the same collection as the target NFT, NFTs minted by the same entity as the target NFTs, and/or NFTs satisfying one or more logical conditions comparing their non-visual features to the non-visual features of the target NFT.

In some implementations, the pairwise similarity score of two images may be computed as follows:

$$Similarity Score = \frac{{U}^{T} V}{‖ U ‖ \times ‖ V ‖}$$

where U and V are feature vectors of the target NFT and a candidate NFT, respectively.

As noted herein above, a feature vector for a given NFT may include an encoded representation produced for the given NFT by the encoder stage of a trained autoencoder.

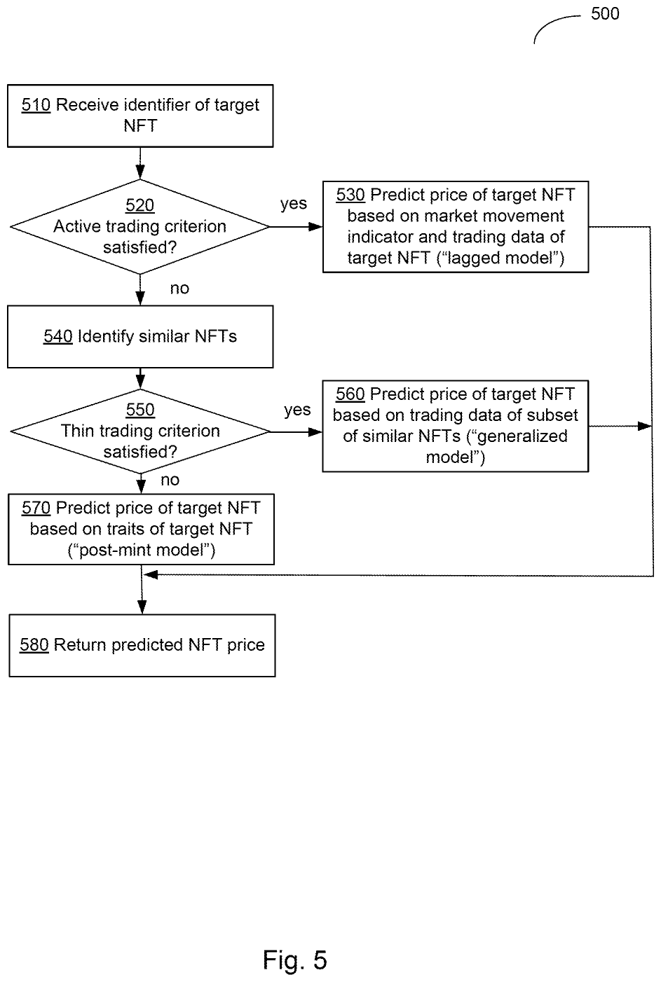

Accordingly, the price prediction module 260 may invoke the similar image identification module 258 for identifying images that are similar to the target NFT. The identified similar NFTs may then be utilized by the price prediction module 260, along with the transaction data and associated metadata for predicting the price of the target NFT, as explained in more detail herein below with reference to FIG. 5. The output of the price prediction module may be fed to the reporting module 270 for presentation, e.g., via a graphical user interface (GUI) 204, an application programming interface (API) 208, etc.

In some implementations, each of the above-described modules may be implemented by a respective dedicated pool of processing threads. “Processing thread” herein shall refer to a sequence of executable instructions that is executed by a physical or virtual processor in a separate execution context or in an execution context which is at least partially shared with other processing threads. The “execution context” herein shall refer to the processor state, the memory state, and the input/output (I/O) device state.

In various implementations, the processing threads my run on respective general purpose processors (e.g., central processing units (CPUs)) and/or specialized processors (e.g., graphical processing units (GPUs)). The number of threads in each pool of processing threads dynamically modified based on one or more operational parameters, such as the incoming transaction rate, the typical transaction processing time, the availability of hardware resources, etc. In an illustrative example, responsive to detecting a surge of the incoming transaction rate of receiving the raw transaction records (e.g., an increase by at least a predefined threshold number of incoming transactions per unit of time that has been observed by at least a predefined period of time), the scheduler of the workflow 200 may increase the number of processing threads that perform the transaction processing operations (e.g., transaction extraction and normalization module 230, metadata extraction and normalization module 240, image extraction and normalization module 250, feature extraction module 254, and/or similar image identification module 256).

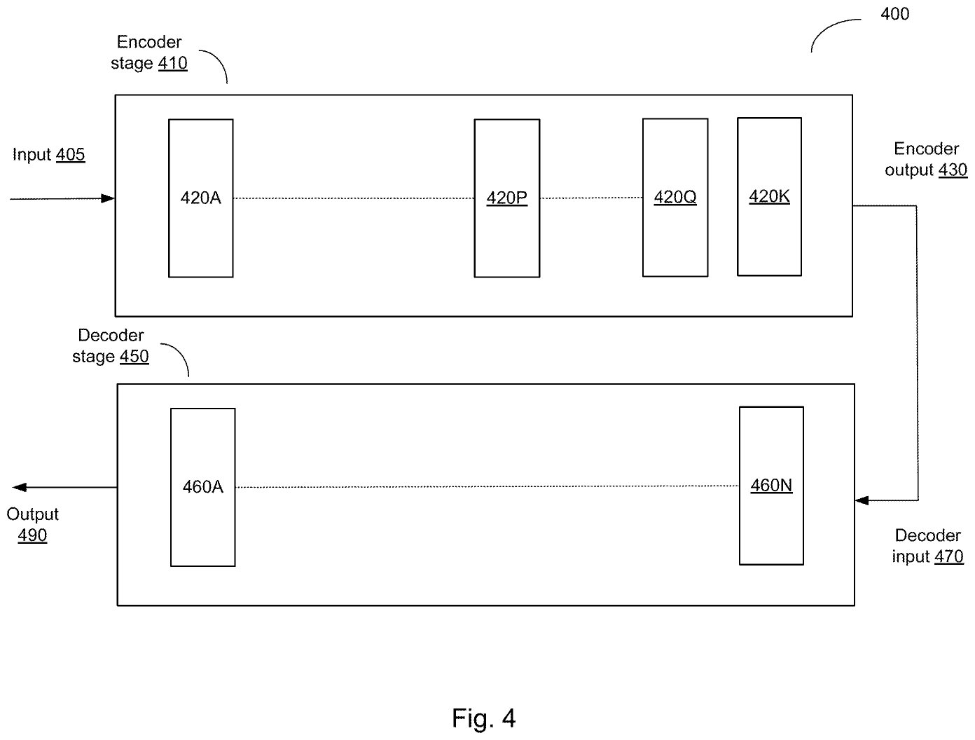

FIG. 4 schematically illustrates an example structure of a neural network implementing an autoencoder in accordance with aspects of the present disclosure. A neural network is a computational model implementing a set of interconnected functional nodes called “artificial neurons.” Each artificial neuron is programmed to change its internal state according to a received input and a specified activation function. A neural network is thus formed by connecting outputs of certain neurons to inputs of other neurons, such that each connection has a weight (e.g., an attenuation/amplification factor) associated with it. The weights and the activation function parameters may be determined by a learning process.

As schematically illustrated by FIG. 4, the example autoencoder 400 is a multi-layer neural network which includes the encoder stage 410 and the decoder stage 450, such that the output 430 of the encoder stage is fed to the input 470 of the decoder stage. Each of the encoder and decoder stages may, in turn, include respective layers 420A-420K and 460A-460N of artificial neurons (e.g., implementing convolutional layers and max-pooling layers). The dimension of the output 490 of the autoencoder (i.e., the size of the output vector of the decoder stage) matches the dimension of the input 405 of the autoencoder (i.e., the size of the input vector of the encoder stage), while the dimension of the output 430 of the encoder stage is significantly less than that of the input 405 and output 490 of the autoencoder.

The k-th feature map for the hidden representation may thus be defined as:

$${h}^{k} = σ ( x * {W}^{k} + {b}^{k} )$$

The reconstruction from the hidden presentation is:

$$y = σ ( {Σ}_{k ∈ H} {h}^{k} * {\hat{W}}^{k} + c )$$

where σ is the activation function;
* is the 2D convolution operator; and
H is the set of latent feature maps.

The autoencoder is trained to produce the encoding of the input by the encoder stage and then reverse the encoding (i.e., restore the original input) by the decoder stage. The autoencoder undergoes an unsupervised learning process, which may involve encoding an input vector (e.g., a digital representation of an image) by the encoder stage to produce an encoded representation of a reduced dimension, decoding the encoded representation to produce an output vector, determining the error as the difference between the output vector and the input vector, and back-propagating the error to adjust the weights and activation function coefficients. The process may be repeated until the error falls below a specified low threshold.

Thus, the encoder stage of the trained autoencoder effectively detects certain characteristic features of the input vector (e.g., a digital representation of an image), which may then be utilized for computing the similarity score of two images as described in more detail herein above.

In some implementations, the encoded representation of the image fed to the input 405 of the encoder stage may be retrieved from the output layer 420K of the encoder stage. Alternatively, the encoded representation of the image fed to the input 405 of the encoder stage may be retrieved from an inner layer 420P-420Q of the encoder stage rather than the output layer 420K of the encoder stage. The optimal layer of the encoder stage may be identified by iterating through a subset of layers of the encoder stage which includes the output layer 420K and a predefined number of layers 420P-420Q that precede the output layer and determining, for each layer of the identified subset of layers 420P-420Q and 420K, a corresponding value of the loss function characterizing, for the chosen pricing model, the cumulative difference between the observed and the predicted prices for a chosen subset of NFTs based on a plurality of observed trades. Then, a layer corresponding to the minimum value of the loss function can be chosen for computing the visual feature vectors of NFTs.

FIG. 5 is a flowchart of a method 500 of predicting the price of a specified target NFT, implemented by a computing system operating in accordance with aspects of the present disclosure. Method 500 and/or each of its individual functions, routines, subroutines, or operations may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 500 may be performed by one or more servers 110A-110N of the example computing system 100 of FIG. 1. In some implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other. Although shown in a particular sequence or order, unless otherwise specified, the order of the operations may be modified. Additionally, one or more operations may be omitted in various implementations.

At operation 510, the computing system implementing the method receives a request for a price of a specified NFT. In an illustrative example, an NFT may be identified by an identifier of the blockchain on which the NFT is recorded, an optional identifier of the NFT collection associated with the NFT, and an identifier of the token associated with the NFT. The token may be identified by an address on the blockchain. In some implementations, the NFT is also associated with a Universal Resource Identifier (URI) referencing, e.g., one or more images associated with the NFT. In some implementations, the request may be received via an application programming interface (API) exposed by the computing system. Alternatively, the request may be received via a graphical user interface (GUI) implemented by the computing system.

At operation 520, the computing system determines whether the target NFT satisfies a chosen active trading frequency criterion. In an illustrative example, the active trading frequency criterion is satisfied if the number of reported transactions for the target NFT exceeds a predefined active trading frequency threshold (e.g., a specified number of transactions within a specified period of time, e.g., 100 transactions within ten days preceding the date for which the price of the target NFT is to be determined). In some implementations, the time window in which the NFT trades are considered may be iteratively increased until a predefined active frequency condition is satisfied on the time window (e.g., the number reported transactions for the target NFT exceeds the number of days within the time window multiplied by a predefined active frequency factor), or until the time window reaches a predefined maximum number of days. In some implementations, the parameters (e.g., the length of the time window and the threshold number of transactions) may be determined by the fitting process of the models that are employed in the price prediction. The model fitting process may involve adjusting the values of these and other parameters to minimize the model error, which is the difference between observed and predicted price based on a number of observed trades.

Accordingly, responsive to determining, at operation 520, that the target NFT satisfies the chosen active trading frequency criterion, the computing system, at operation 530, applies the lagged model for actively traded NFTs, which predicts the price of the target NFT based on a cryptoasset market movement indicator and the available trading data associated with the target NFT and, as described in more detail herein below. Responsive to completing the operation 530, the processing continues at operation 580.

Conversely, responsive to determining, at operation 520, that the target NFT fails to satisfy the chosen active trading frequency criterion, the computing system, at operation 540, identifies a subset of NFTs that are similar to the target NFT under a chosen similarity criterion. The similar NFTs may come from the same NFT collection as the target NFT and/or from other NFT collections. The NFT similarity criterion may be based on a similarity score utilizing the visual features extracted from the NFT images, such that each NFT image can be characterized by a visual feature vector, which is a vector of numeric values. In some implementations, the NFT similarity score may further take into account various non-visual features (e.g., attributes) of the target NFT, which may be extracted from the metadata associated with the target NFT. Accordingly, should the value of the similarity score between the vector of features of the target NFT and the vector of features of a candidate NFT be below a predefined threshold, the similarity criterion is satisfied and the candidate NFT may be found to be similar to the target NFT. The visual and/or non-visual features may be extracted from the NFT images by a feature extractor (e.g., represented by a trainable neural network), as described in more detail herein below.

Accordingly, responsive to determining, at operation 550, that a thin trading criterion is satisfied with respect to the identified similar NFTs of the target NFT, the processing may continue at operation 560. The thin trading criterion may be based on a predefined threshold number of reported trades within a predefined period (e.g., 100 transactions within ten days preceding the date for which the price of the target NFT is to be determined). In some implementations, the time window in which the NFT trades are considered may be iteratively increased until a predefined active frequency condition is satisfied on the time window (e.g., the number reported transactions for the target NFT exceeds the number of days within the time window multiplied by a predefined active frequency factor), or until the time window reaches a predefined maximum number of days. In some implementations, the parameters (e.g., the length of the time window and the threshold number of transactions) may be determined by the fitting process of the models that are employed in the price prediction. The model fitting process may involve adjusting the values of these and other parameters to minimize the model error, which is the difference between observed and predicted price based on a number of observed trades.

Accordingly, the thin trading criterion may be satisfied by successfully identifying among the same NFT collection as the target NFT and/or among other NFT collections, a subset including at least a predefined number of NFTs that are similar to the target NFT based on their respective pairwise similarity scores with the target NFT, such that the subset would have at least the threshold number of reported trades within the predefined period.

Thus, responsive to determining, at operation 550, that a thin trading criterion is satisfied with respect to the identified similar NFTs of the target NFT, the computing system may, at operation 560, apply the generalized model for thinly traded NFTs. The generalized model predicts the price of the target NFT based on the identified recent trading data of the identified subset of similar NFTs, as described in more detail herein below. Responsive to completing the operation 560, the processing continues at operation 580.

Conversely, upon failing to identify, at operation 550, the requisite subset of NFTs that are similar to the target NFT, such that the subset would have at least the threshold number of reported trades within the predefined period, the computing system may, at operation 570, apply the post-mint valuation model, which, in the absence of pertinent trading data, predicts the NFT price based on the traits of the NFT, as described in more detail herein below. Responsive to completing the operation 570, the processing continues at operation 580.

At operation 580, the computing system returns the predicted NFT price to the requestor. In some implementations, the predicted NFT price may be returned in response to the API call requesting the NFT price. Alternatively, the predicted NFT price may be visually rendered via a GUI implemented by the computing system. In various implementations, the visual representations may be in the form of tables, 2-D or 3-D plots, diagrams, etc.

In some implementations, the above-noted thresholds (e.g., the minimum number of reported trades that should be available for selecting the generalized model or the lagged model) may be chosen to minimize the difference between the outputs of the two models in the vicinity of the threshold.

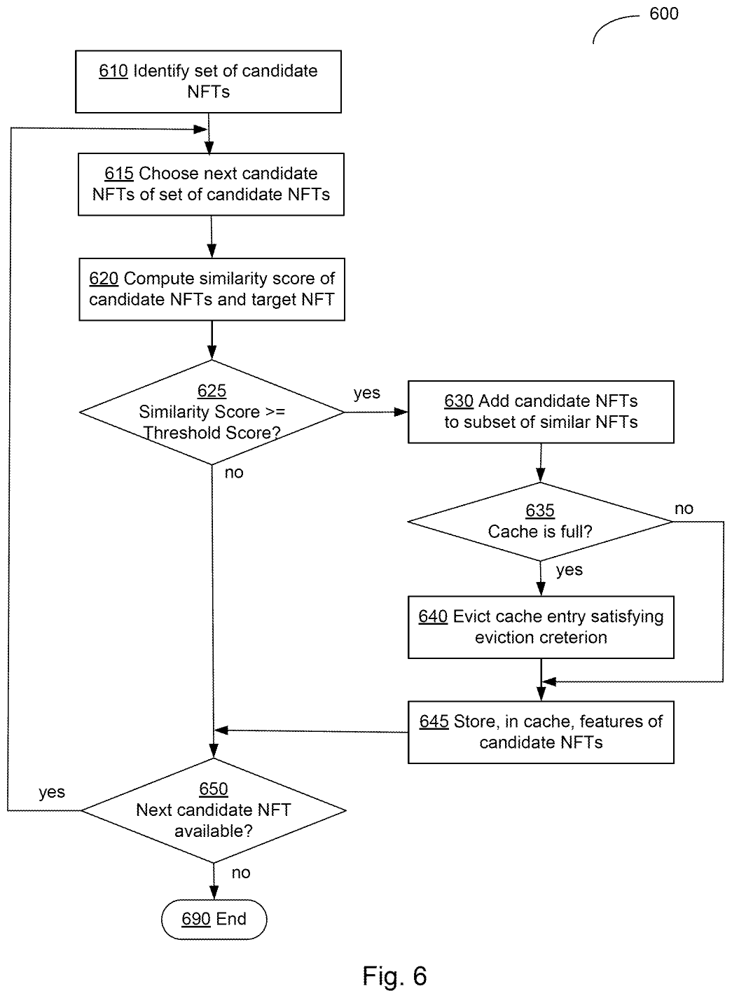

FIG. 6 is a flowchart of a method 600 of identifying a set of NFTs that are similar, in view of a chosen similarity score, to a specified target NFT, implemented by a computing system operating in accordance with aspects of the present disclosure. Method 600 and/or each of its individual functions, routines, subroutines, or operations may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 600 may be performed by one or more servers 110A-110N of the example computing system 100 of FIG. 1. In some implementations, method 600 may be performed by a single processing thread. Alternatively, method 600 may be performed by two or more processing threads, each thread executing one or more individual functions, routines, subroutines, or operations of the method. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other. Although shown in a particular sequence or order, unless otherwise specified, the order of the operations may be modified. Additionally, one or more operations may be omitted in various implementations.

At operation 610, the computing system implementing the method identifies a set of candidate NFTs. In various illustrative examples, the set of candidate NFTs may include NFTs from the same collection as the target NFT, NFTs minted by the same entity as the target NFTs, and/or NFTs satisfying one or more logical conditions comparing their non-visual features to the non-visual features of the target NFT.

At operations 615-650, the computing system iterates through the set of candidate NFTs; in particular, at operation 615, the next unprocessed candidate NFT is selected.

At operation 620, the computing system computes the similarity score of the selected candidate NFT with the target NFT. In some implementations, the similarity score may reflect a distance metric between a vector of visual features of the candidate NFT and a vector of visual features of the target NFT, as described in more detail herein above.

Responsive to determining, at operation 625, that the similarity score of the candidate NFT with the target NFT falls below a predefined threshold similarity score, method branches to at operation 630; otherwise, the processing continues at operation 650.

Conversely, responsive to determining, at operation 625, that the similarity score of the candidate NFT with the target NFT exceeds or is equal to a predefined threshold similarity score, the computing system, at operation 630, adds the candidate NFT to the set of similar NFTs. In some implementations, the threshold similarity score may be determined by the model fitting process, which may involve adjusting the threshold similarity score to minimize the model error, which is the difference between observed and predicted price based on a number of observed trades.

Responsive to determining, at operation 635, that the memory buffer utilized for caching the NFT features is full, the computing system, at operation 640, evicts, from the feature cache, a cache entry storing a feature vector of an NFT having a most recent transaction date that satisfies a staleness criterion. In an illustrative example, the staleness criterion is satisfied when the time decay factor computed based on the most recent transaction date does not exceed a predefined low sensitivity threshold, as described in more detail herein below.

At operation 645, the computing system stores, in the cache, a vector of visual features of the candidate NFT, as described in more detail herein above.

Responsive to determining, at operation 650, that the set of candidate NFTs has not yet been exhausted, the method loops back to operation 615; otherwise, the method terminates at operation 660. The identified set of similar NFTs may be utilized by the post-mint model and/or generalized model, as described in more detail herein below.

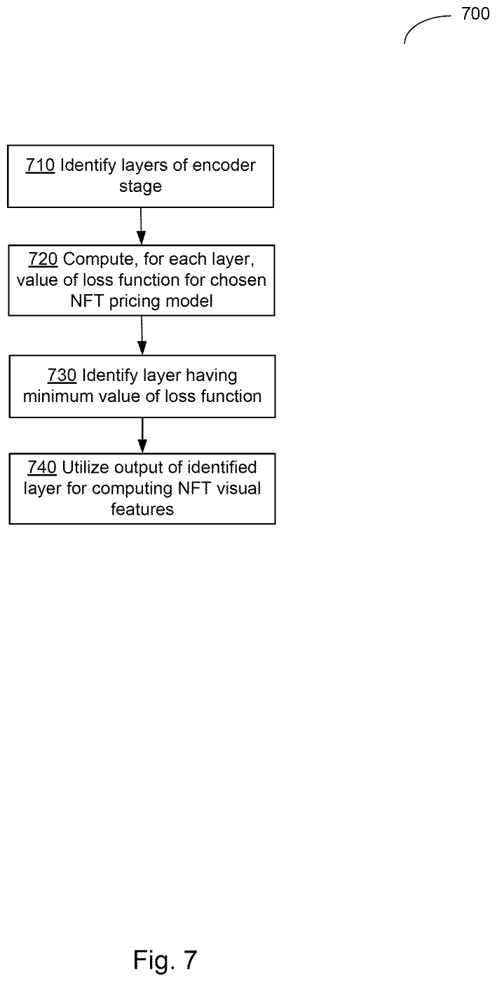

FIG. 7 is a flowchart of a method 700 of selecting a layer of the decoder stage of an autoencoder that is employed for extracting visual features from an NFT image by a computing system operating in accordance with aspects of the present disclosure. Method 700 and/or each of its individual functions, routines, subroutines, or operations may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 700 may be performed by one or more servers 110A-110N of the example computing system 100 of FIG. 1. In some implementations, method 700 may be performed by a single processing thread. Alternatively, method 700 may be performed by two or more processing threads, each thread executing one or more individual functions, routines, subroutines, or operations of the method. In an illustrative example, the processing threads implementing method 700 may be synchronized (e.g., using semaphores, critical sections, and/or other thread synchronization mechanisms). Alternatively, the processing threads implementing method 700 may be executed asynchronously with respect to each other. Although shown in a particular sequence or order, unless otherwise specified, the order of the operations may be modified. Additionally, one or more operations may be omitted in various implementations.

At operation 710, the computing system implementing the method identifies, in a trained autoencoder that includes a multi-layer encoder stage and a multi-layer decoder stage, a set of candidate layers of the encoder stage. In an illustrative example, the set of candidate layers can include the output layer and a predefined number (e.g., ten) of preceding layers of the encoder stage, as described in more detail herein below.

At operation 720, the computing system determines, for each layer of the set of candidate layers, a corresponding value of a loss function for the pricing model utilized for predicting the price of the target NFT. In an illustrative example, the loss function characterizes characterizing, for the chosen pricing model, the cumulative difference between the observed and the predicted prices for a chosen subset of NFTs based on a plurality of observed trades.

At operation 730, the computing system selects, among the set of candidate layers, the layer corresponding to the minimum value of the loss function, as described in more detail herein below.

At operation 740, the computing system utilizes the output of the selected layer as the vector of visual features of the image that has been fed to the input of the encoder stage. The feature vector may be utilized for computing NFT similarity scores, as described in more detail herein above.

As noted herein above, valuation of a target NFT may be performed by applying one or more valuation models, which may be chosen based on the lifecycle stage of the target NFT and/or availability of trading data that is pertinent to the target NFT.

In particular, a recently minted NFT might not have any observed trades. In the absence of pertinent trading data (e.g., when the number of reported trades associated with the target NFT and/or other NFTs in the same NFT collection is below a predefined low threshold), the post-mint model may be employed, which predicts the NFT value based on the traits of the NFT.

In some implementations, the NFT price may be described by the following equation:

$$ln ( {PriceNFT}_{i} ) = {α}_{0} + {\sum }_{k = 1}^{k = K} {β}_{k} {Trait}_{k} + γ {d}_{i} + {ϵ}_{i}$$

where PriceNFTᵢ is the first trade price of the target NFTi after minting;
dᵢ is the number of days elapsed after minting;
βₖ is the weight coefficient for trait k, which shows the relative change in the NFT price if traitₖ is available for the target NFT.
K is the number of traits identified in the target NFT;
γdᵢ, ϵᵢ, and α₀ are the model coefficients to be determined by the model fitting process.

The fitting process of the model may involve adjusting the values of the coefficients to minimize the model error, which is the difference between observed and predicted price based on a number of observed trades.

As noted herein above, a thinly traded NFT may be valued by the generalized valuation model which assumes that similar assets should have similar market price and thus utilizes the available trading data from the collection to which the target NFT belongs or from similar collections. In the absence of the trading data that would be sufficient to utilize the lagged model (e.g., when the number of reported trades associated with the target NFT and/or other NFTs in the same NFT collection is below a predefined high threshold), the generalized model may utilize the trading data of similar NFTs for predicting the price of the target NFT.

Accordingly, the computing system may identify a set of candidate NFTs from the same NFT collection as the target NFT and/or from other NFT collections. Upon identifying, among the set of candidate NFTs, a subset of at least a predefined number of NFTs that are similar to the target NFT based on their respective pairwise similarity scores with the target NFT, the computing system may then retrieve the recent trade data of the identified similar NFTs and utilize the trade prices of the identified similar NFTs as inputs to the generalized model to predict the price of the target NFT:

$$Log ( {NFTProce}_{i , c , t} ) = {\sum }_{j = 1}^{n} {w}_{j} \times log [ {NFTPrice}_{j} ] / {\sum }_{j = 1}^{n} {w}_{j} = {\sum }_{j = 1}^{n} log [ {NFTProce}_{c , j , {t}_{j}} \times {e}^{{λ}_{j} \times {δ}_{j} \times ( 1 - {sim}_{i , j} )} ] / {\sum }_{j 321}^{n} {λ}_{j} \times {δ}_{j} \times ( 1 - {sim}_{i , j} )$$

where NFTPrice is the predicted price of the target NFT;
c is the identifier of the collection;
i is an identifier of the target NFT in the collection;
t is the timestamp of the prediction;
j is an identifier of another NFT in the collection;
n is the number of similar NFTs in the collection.
δⱼ is the decay factor; in some implementations,

$${δ}_{j} = \frac{( t - {t}_{j} )}{365.25} ,$$

where tⱼ is the timestamp of the last trade of NFTⱼ;
wⱼ is the weight coefficient; wⱼ=Δⱼ×δⱼ×(1−sim_{i,j}) and wⱼ>=0
sim_{i,j} is the similarity score of NFTᵢ and NFTⱼ. In some implementations, the value may be normalized to (0; 1) range, such that sim_{i,j}=1 if NFTᵢ and NFTⱼ are the same NFT.
λⱼ—is a model coefficient to be identified by the fitting process.

The fitting process of the model may involve adjusting the values of the coefficients to minimize the model error, which is the difference between observed and predicted price based on a number of observed trades.

As noted herein above, an actively traded NFT may be valued by the lagged model which predicts the price of the target NFT based on the available trading data associated with the target NFT and a cryptoasset market movement indicator:

$$ln ( {PriceNFT}_{i} ) = {α}_{0} + {β}_{1} ln ( {TargetNFT}_{i , t - 1} ) + {β}_{2} Δ {Market}_{t} + {e}_{i , t}$$

where PriceNFT_{i,t} is the trade price of NFT i on day t.
ΔMarketₜ is the cryptoasset market movement indicator from day t−1 to day t; and
αₒ, β₁, β₂, and e_{i,t} are the model coefficients to be determined by the model fitting process:
   αₒ is a model coefficient that reflects the drift in NFT prices;
   β₁ is a model coefficient that shows the weight associated with the prior trade price of the NFT;
   β₂ is a model coefficient reflecting the change in the NFT price with the growth of the NFT market; and
   e_{i,t} is the term error in the prediction.

The cryptoasset market movement indicator may be represented, e.g., by the difference in traded prices of a specified cryptocurrency, e.g., ETH.

The fitting process of the model may involve adjusting the values of the coefficients to minimize the model error, which is the difference between observed and predicted price based on a number of observed trades.

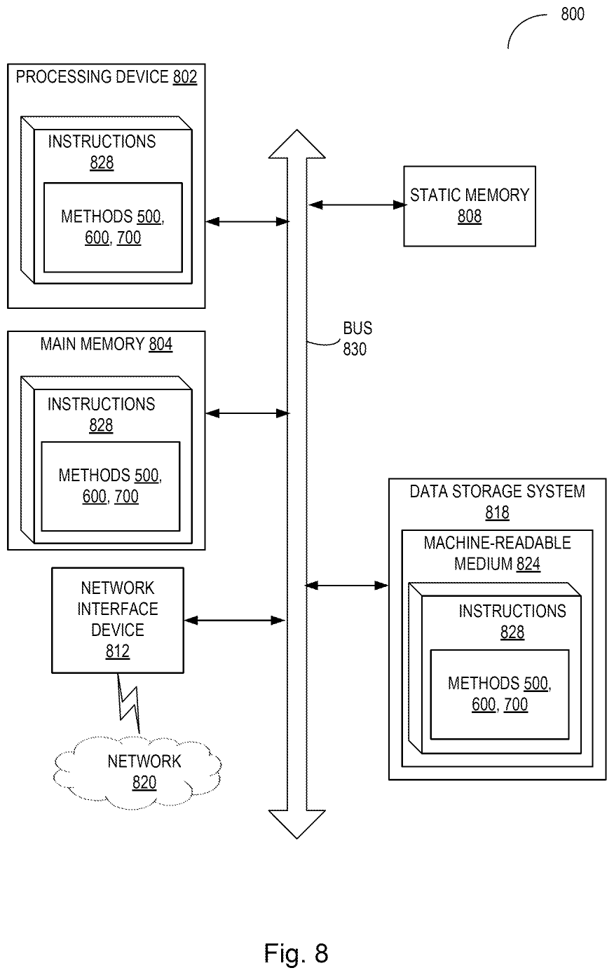

FIG. 8 illustrates an example machine of a computing system 800 within which a set of instructions, for causing the machine to perform any one or more of the methods discussed herein, may be executed. In some embodiments, the computing system 800 may be a computing device that includes a processor with a cache controller, a memory controller, or combination thereof. In alternative embodiments, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methods discussed herein.

The example computing system 800 includes a processing device 802 (e.g., comprising one or more general purpose and/or specialized processors), a main memory 804 (e.g., read-only memory (ROM), flash memory, dynamic random access memory (DRAM) such as synchronous DRAM (SDRAM), etc.), a static memory 808 (e.g., flash memory, static random access memory (SRAM), etc.), a network interface device 812, and a data storage system 818, which communicate with each other via a bus 830.

Processing device 802 may represent one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, bus controller, peripheral device controller, or the like. The processing device 802 is configured to execute instructions 828 for performing the operations and steps discussed herein. The computing system 800 may further include a network interface device 812 to communicate over the network 820.

The data storage system 818 may include a machine-readable storage medium 824 (also known as a non-transitory computer-readable medium) on which is stored one or more sets of instructions 828 or software embodying any one or more of the methods or functions described herein. The instructions 828 may also reside, completely or at least partially, within the main memory 804 and/or within the processing device 802 during execution thereof by the computing system 800, the main memory 804 and the processing device 802 also constituting machine-readable storage media. In one embodiment, the instructions 828 include instructions to the method 500 of predicting the price of a specified target NFT, method 600 of identifying a set of NFTs that are similar, in view of a chosen similarity score, to a specified target NFT, and/or method 700 of selecting a layer of the decoder stage of an autoencoder that is employed for extracting visual features from an NFT image.

While the machine-readable storage medium 824 is shown in an example embodiment to be a single medium, the term “non-transitory machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methods of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure may refer to the action and processes of a computing system, or similar electronic computing device, that manipulates and transforms data represented as physical (electronic) quantities within the computing system's registers and memories into other data similarly represented as physical quantities within the computing system memories or registers or other such information storage systems.

The present disclosure also relates to an apparatus for performing the operations herein. This apparatus may be specially constructed for the intended purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computing system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computing system (or other electronic devices) to perform a process according to the present disclosure. A machine-readable medium includes any mechanism for storing information in a form readable by a machine (e.g., a computer). In some embodiments, a machine-readable (e.g., non-transitory computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications may be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, by a computing system, an identifier of a target nun-fungible token (NFT);
responsive to determining, based on first trading data associated with the target NFT, that the target NFT fails to satisfy an active trading frequency criterion, identifying a subset of similar NFTs including at least a predefined number of NFTs that satisfy a chosen similarity criterion based on their respective similarity scores with the target NFT, wherein the subset of similar NFTs is associated with at least a predefined number of reported trades within a predefined period; and
predicting the price of the target NFT based on second trading data associated with the identified subset of similar NFTs.

2. The method of claim 1, wherein identifying the subset of similar NFTs further comprises:
identifying a plurality of candidate NFTs;
computing, for each candidate NFT of the plurality of candidate NFTs, a similarity score with the target NFT, wherein the similarity score reflects a distance metric between a first vector representing visual features of the candidate NFT and a second vector representing visual features of the target NFT; and
responsive to determining that the similarity score of a candidate NFT with the target NFT exceeds a predefined threshold similarity score, including the candidate NFT into the subset.

3. The method of claim 2, wherein computing the similarity score further comprises:
evicting, from a feature cache, a cache entry storing a feature vector of an NFT having a most recent transaction date satisfying a staleness condition that compares, to a low sensitivity threshold, a time decay factor computed based on the most recent transaction date; and
storing, in the cache entry, the first vector representing visual features of the candidate NFT.

4. The method of claim 2, wherein computing the similarity score further comprises:
identifying, in an autoencoder comprising a multi-layer encoder stage and a multi-layer decoder stage, a plurality of layers of the encoder stage;
computing, for each layer of the plurality of layers, a corresponding value of a loss function for a pricing model utilized for predicting the price of the target NFT;
selecting, among the plurality of layers, a layer corresponding to a minimum value of the loss function; and
utilizing an output of the selected layer to compute the first vector representing visual features of the candidate NFT and the second vector representing visual features of the target NFT.

5. The method of claim 1, wherein the active trading frequency criterion specifies a threshold number of reported transactions for the target NFT within a specified period of time.

6. The method of claim 1, further comprising:
determining, for a pricing model utilized for predicting the price of the target NFT, values of one or more coefficients of that minimize a difference between observed and predicted price based on a plurality of observed trades.

7. The method of claim 1, further comprising:
visually representing the predicted price of the target NFT.

8. The method of claim 1, further comprising:
responsive to determining that the target NFT satisfies an active trading frequency criterion, predicting a price of the target NFT based on the first trading data and a cryptoasset market movement indicator derived from a traded price of a predefined cryptoasset.

9. The method of claim 1, further comprising:
responsive to failing to identify a subset including at least a predefined number of NFTs that are similar to the target NFT based on their respective pairwise similarity scores with the target NFT, predicting the price of the target NFT based on traits of the target NFT.

10. A system comprising:
a memory;
a processing device, communicably coupled to the memory, the processing device configured to:
receive an identifier of a target nun-fungible token (NFT);
responsive to determining, based on first trading data associated with the target NFT, that the target NFT fails to satisfy an active trading frequency criterion, identify a subset of similar NFTs including at least a predefined number of NFTs that satisfy a chosen similarity criterion based on their respective similarity scores with the target NFT, wherein the subset of similar NFTs is associated with at least a predefined number of reported trades within a predefined period; and
predict the price of the target NFT based on second trading data of the identified subset of similar NFTs.

11. The system of claim 10, wherein identifying the subset of similar NFTs further comprises:
identifying a plurality of candidate NFTs;
computing, for each candidate NFT of the plurality of candidate NFTs, a similarity score with the target NFT, wherein the similarity score reflects a distance metric between a first vector representing visual features of the candidate NFT and a second vector representing visual features of the target NFT; and
responsive to determining that the similarity score of a candidate NFT with the target NFT exceeds a predefined threshold similarity score, including the candidate NFT into the subset.

12. The system of claim 11, wherein computing the similarity score further comprises:
evicting, from a feature cache, a cache entry storing a feature vector of an NFT having a most recent transaction date satisfying a staleness condition that compares, to a low sensitivity threshold, a time decay factor computed based on the most recent transaction date; and
storing, in the cache entry, the first vector representing visual features of the candidate NFT.

13. The system of claim 11, wherein computing the similarity score further comprises:
identifying, in an autoencoder comprising a multi-layer encoder stage and a multi-layer decoder stage, a plurality of layers of the encoder stage;
computing, for each layer of the plurality of layers, a corresponding value of a loss function for a pricing model utilized for predicting the price of the target NFT;
selecting, among the plurality of layers, a layer corresponding to a minimum value of the loss function; and
utilizing an output of the selected layer to compute the first vector representing visual features of the candidate NFT and the second vector representing visual features of the target NFT.

14. The system of claim 10, wherein the processing device is further configured to:
visually represent the predicted price of the target NFT.

15. The system of claim 10, wherein the processing device is further configured to:
responsive to failing to identify a subset including at least a predefined number of NFTs that are similar to the target NFT based on their respective pairwise similarity scores with the target NFT, predict the price of the target NFT based on traits of the target NFT.

16. A non-transitory machine-readable storage medium comprising executable instructions which, when executed by a processing device, cause the processing device to:
receive an identifier of a target nun-fungible token (NFT);
responsive to determining, based on first trading data associated with the target NFT, that the target NFT fails to satisfy an active trading frequency criterion, identify a subset of similar NFTs including at least a predefined number of NFTs that satisfy a chosen similarity criterion based on their respective similarity scores with the target NFT, wherein the subset of similar NFTs is associated with at least a predefined number of reported trades within a predefined period; and
predict the price of the target NFT based on second trading data of the identified subset of similar NFTs.

17. The non-transitory machine-readable storage medium of claim 16, wherein identifying the subset of similar NFTs further comprises:
identifying a plurality of candidate NFTs;
computing, for each candidate NFT of the plurality of candidate NFTs, a similarity score with the target NFT, wherein the similarity score reflects a distance metric between a first vector representing visual features of the candidate NFT and a second vector representing visual features of the target NFT; and
responsive to determining that the similarity score of a candidate NFT with the target NFT exceeds a predefined threshold similarity score, including the candidate NFT into the subset.

18. The non-transitory machine-readable storage medium of claim 17, wherein computing the similarity score further comprises:
evicting, from a feature cache, a cache entry storing a feature vector of an NFT having a most recent transaction date satisfying a staleness condition that compares, to a low sensitivity threshold, a time decay factor computed based on the most recent transaction date; and
storing, in the cache entry, the first vector representing visual features of the candidate NFT.

19. The non-transitory machine-readable storage medium of claim 17, wherein computing the similarity score further comprises:
identifying, in an autoencoder comprising a multi-layer encoder stage and a multi-layer decoder stage, a plurality of layers of the encoder stage;
computing, for each layer of the plurality of layers, a corresponding value of a loss function for a pricing model utilized for predicting the price of the target NFT;
selecting, among the plurality of layers, a layer corresponding to a minimum value of the loss function; and
utilizing an output of the selected layer to compute the first vector representing visual features of the candidate NFT and the second vector representing visual features of the target NFT.

20. The non-transitory machine-readable storage medium of claim 16, further comprising executable instructions which, when executed by the processing device, cause the processing device to:
responsive to failing to identify a subset including at least a predefined number of NFTs that are similar to the target NFT based on their respective pairwise similarity scores with the target NFT, predict the price of the target NFT based on traits of the target NFT.
